(19) United States
(12) Patent Application Publication
(10) Pub. No.: US 2007/0111044 A1
(43) Pub. Date: May 17, 2007

(54) Hybrid cell and method of driving the same

(76) Inventor: Seok Gyun Chang, Youngin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/506,308

(22) Filed: Aug. 17, 2006

(30) Foreign Application Priority Data
Aug. 17, 2005 (KR) 10-2005-0075160
Sep. 5, 2005 (KR) 10-2005-0082393

(51) Int. Cl. H01M 16/00; H01M 4/58; H01M 4/50; H01M 4/48; H01M 4/52; H01M 10/44; H01M 8/04

(52) U.S. Cl. 429/9; 429/231.95; 429/231.1; 429/231; 429/231.5; 429/231.3; 429/223; 429/224; 429/50; 429/23; 320/101

(57) ABSTRACT

A hybrid cell including a lithium secondary battery having a linear voltage profile and a fuel cell, and a method of driving the same are disclosed. The lithium secondary battery having the linear voltage profile is fabricated by combining a plurality of positive electrode active materials having various electric potentials. The lithium secondary battery is hybridized with the fuel cell, thereby obtaining the hybrid cell having a small size and a high energy capacity, which is controllable by a controller having a relatively simple structure.

### CROSS-REFERENCE TO RELATED APPLICATIONS

This application claims the benefit of Korean Patent Application No. 10-2005-0075160, filed on Aug. 17, 2005, and Korean Patent Application No. 10-2005-0082393, filed on Sep. 5, 2005, in the Korean Intellectual Property Office, the disclosures of which are incorporated herein by reference.

### BACKGROUND OF THE INVENTION

1. Field of the Invention

The present invention relates to a hybrid cell and a method of driving the same. More particularly, the present invention relates to a hybrid cell having a lithium secondary battery and a fuel cell, and a method of driving the same.

2. Description of the Related Technology

As generally known in the art, a fuel cell is a new power generation system capable of directly converting energy, which is created through an electrochemical reaction between fuel gas and oxidizing gas, into electrical energy. Similar to a typical battery, the fuel cell includes two electrodes and an electrolyte. However, the fuel cell is different from the typical battery because a fuel and oxidant are continuously fed into the fuel cell. That is, the typical battery is discarded when the active reactant contained in the typical battery has been completely consumed due to the long-time use of the typical battery. In the case of a rechargeable battery, electric energy is supplied to the rechargeable battery from an external source after the initial discharge of the rechargeable battery, and thus the rechargeable battery simply serves as an energy storage unit. In contrast, unlike a normal chemical battery causing an electrochemical reaction in a closed system, the fuel cell is an energy converter capable of converting chemical energy into electrical energy by allowing the reactant and product to pass through the fuel cell.

In addition, a fuel cell generates the electrical energy through an electrochemical reaction, rather than combustion. Thus, a fuel cell can improve heat efficiency while minimizing byproducts that cause environmental pollution. Such a fuel cell has been actively researched as a power source for power plants, air bases, marine wireless equipment, mobile or stationary wireless equipment, vehicles, household appliances, or electric equipment for leisure activity.

Fuel cells are mainly classified into phosphoric acid fuel cells operating at a temperature of about 200° C., alkaline fuel cells operating at a normal temperature or at a temperature of about 100° C. or less, molten carbonate fuel cells operating at a high temperature of about 500 to 700° C., and solid oxide fuel cells operating at a super-high temperature of about 1000° C. or more. In practice, the fuel cell can generate a voltage of about 0.7 to 1.0V under a current density of about 100 to 200 mA/cm². A user can connect the fuel cells in series or in a row in order to obtain a higher voltage or a higher current. Such a connection structure of the fuel cells is called a “stack structure.” In general, the stack structure is obtained by connecting the fuel cells in series, in which a bipolar plate connects a positive pole of a unit cell to a negative pole of the next cell. The bipolar plate is made from a material capable of easily flowing the current and having superior oxidation-reduction resistant characteristics at the negative and positive poles.

The fuel cell continuously produces electrical energy so long as fuel is fed into the fuel cell. However, the fuel cell system is not suitable where a great amount of power is required. In such a case, a fuel cell is combined with a battery or a super capacitor, such as an electrochemical double layer capacitor or a pseudo capacitor. The electrochemical double layer capacitor (hereinafter, referred to as EDLC) accumulates electrical energy by storing electric charges on an electrical double layer formed at an interface between a solid electrode and an electrolyte. Although the EDLC has a lower energy density of about 1 to 10 Wh/kg, which is lower than that of a lithium secondary battery, it can shorten a charge time and increase an output density to a level of about 1000 to 2000 W/kg while greatly expanding the cycle life. Thus, the EDLC has been spotlighted in various fields, such as an electric vehicle field.

Meanwhile, although a lithium secondary battery has a higher energy density of about 20 to 120 Wh/kg, it generates a lower output density of about 50 to 250 W/kg and deteriorates the life cycle characteristic to a level of about 500 cycles.

As to a voltage profile, the EDLC exhibits a voltage profile similar to that of the fuel cell although the EDLC has a lower energy density. The EDLC may be extensively used to backup the power of the fuel cell. In contrast, although the lithium secondary battery has a higher energy density, the lithium secondary battery exhibits a voltage profile different from that of the fuel cell.

Thus, an expensive controller must be provided between the fuel cell and the lithium secondary battery for hybridization. In particular, a controller is required to determine the amount of a charge current by measuring an electric potential of the battery in real time even if the lithium secondary battery is installed in a portable device having a small capacity. In addition, the controller typically has a complex circuit structure for the purpose of precision. Thus, the lithium secondary battery is not suitable for a mass storage and high voltage power source, such as a power source for a vehicle.

Meanwhile, the EDLC has a voltage profile similar to the voltage profile of the fuel cell. Thus, the controller can be constructed with a simple structure. However, the EDLC has a large size and has a lower operational voltage of about 2.3 to 2.7V. Thus, a plurality of stacks of the fuel cells is necessary and an energy density of the EDLC is low.

### SUMMARY OF CERTAIN INVENTIVE ASPECTS

One aspect of the invention provides a hybrid cell. The hybrid cell comprises: a lithium secondary battery comprising an electrode assembly and a housing for accommodating the electrode assembly therein, the electrode assembly comprising: a positive electrode comprising a positive electrode active material, and a negative electrode comprising a negative electrode active material, wherein the lithium secondary battery comprises a substantially linear time-to-voltage profile in at least part of a charging and discharging cycle thereof; a fuel cell electrically connected to the lithium secondary battery; and a controller for controlling the lithium secondary battery and the fuel cell.

The lithium secondary battery may have a substantially linear time-to-voltage profile with a negative slope while discharging. The lithium secondary battery may not comprise a substantially horizontal time-to-voltage profile. The lithium secondary battery may not comprise a substantially horizontal time-to-voltage profile while discharging the battery.

The positive electrode active material may comprise at least two materials selected from the group consisting of LiₓWO₃, LiₓMoO₂, LiₓTiS₂, LiₓMoS₂, LiₓMnO₄, Li₁₋ₓMn₂O₄, Li₁₋ₓNiO₂, Li₁₋ₓCoO₂, LiNiVO₄, LiF, and LiₓNi_{y}Co_{z}Al_{1-y-z}O₂. In each of LiₓWO₃, LiₓMoO₂, LiₓTiS₂, LiₓMoS₂, LiₓMnO₄, Li₁₋ₓMn₂O₄, Li₁₋ₓNiO₂, and Li₁₋ₓCoO₂, x is greater than 0 and not greater than 1. In LiₓNi_{y}Co_{z}Al_{1-y-z}O₂, each of x,y, and z is greater than 0 and not greater than 1, and a sum of y and z is greater than 0 and not greater than 1. The positive electrode active material may comprise LiNi_{1/3}Co_{1/3}Al_{1/3}O₂ and LiMn₂O₄. A weight ratio of LiNi_{1/3}Co_{1/3}Al_{1/3}O₂ to LiMn₂O₄ may be about 1:1. The negative electrode active material may comprise graphite.

The positive electrode active material may comprise LiNiCoMnO₂ and Li₂CoO₂. The negative electrode active material may comprise hard carbon comprising micro crystals having a surface interval of about 0.337 nm or greater. The lithium secondary battery may further comprise an electrolyte, and the electrolyte may comprise LiPF₆.

The controller may be configured to detect a voltage level of the lithium secondary battery, and the controller may be further configured to control charging of the lithium secondary battery such that the secondary battery is charged to a predetermined voltage in accordance with the substantially linear voltage profile. When the voltage level of the lithium secondary battery is equal to or greater than a first voltage, the controller may be configured to stop charging the lithium secondary battery.

The hybrid cell may further comprise a charge control device configured to charge the lithium secondary battery using the fuel cell or an external power. The controller may be configured to control at least one of the lithium secondary battery and the fuel cell in the at least part of the charging and discharging cycle.

The fuel cell may have a discharge voltage profile, at least part of which is substantially linear, and the substantially linear voltage profile of the lithium secondary battery may be substantially parallel to the discharge voltage profile of the fuel cell. The substantially linear voltage profile of the lithium secondary battery may substantially match the discharge voltage profile of the fuel cell. The substantially linear voltage profile of the lithium secondary battery may have a slope different from that of the discharge voltage profile of the fuel cell.

Another aspect of the invention provides a method of driving a hybrid cell described above. The method comprises: detecting a voltage level of the lithium secondary battery; charging the lithium secondary battery in accordance with a substantially linear voltage profile if the voltage level of the lithium secondary battery is substantially smaller than a first predetermined level; and stopping charging the lithium secondary battery if the voltage level reaches about the predetermined level.

The method may further comprise: detecting an output voltage and an output current of the fuel cell; determining whether an output power of the fuel cell has decreased; discharging the lithium secondary battery in accordance with a substantially linear voltage profile if the output power of the fuel cell has suddenly decreased; and stopping discharging the lithium secondary battery if the voltage level of the lithium secondary battery reaches about a second predetermined level.

Another aspect of the invention provides a hybrid cell and a method of driving the same, in which a voltage profile of a lithium secondary battery is similar to that of a fuel cell, so that the lithium secondary battery can be easily hybridized with the fuel cell, thereby exchanging an expensive controller with a controller having a low price and a simple structure, and in which the lithium secondary battery has an energy capacity and an operational voltage, which are significantly higher than those of an EDLC, so that the efficiency of stacks of the fuel cell can be maximized.

Another aspect of the invention provides a hybrid cell comprising: a lithium secondary battery including an electrode assembly and a case for accommodating the electrode assembly therein, the electrode assembly including a positive electrode active material having a positive electrode active material and a negative electrode active material having a negative electrode active material, the lithium secondary battery representing a linear voltage profile during at least one of charge and discharge operations; a fuel cell electrically connected to the lithium secondary battery; and a controller for controlling the lithium secondary battery and the fuel cell.

The positive electrode active material includes a combination of at least two positive electrode active materials. In addition, the positive electrode active material includes a combination having at least two selected from the group consisting of LiₓWO₃, LiₓMoO₂, LiₓTiS₂, LiₓMoS₂, LiₓMnO₄, Li₁₋ₓMn₂O₄, Li₁₋ₓNiO₂, Li₁₋ₓCoO₂, LiNiVO₄, LiF, and LiₓNi_{y}Co_{z}Al_{1-y-z}O₂. In each of LiₓWO₃, LiₓMoO₂, LiₓTiS₂, LiₓMoS₂, LiₓMnO₄, Li₁₋ₓMn₂O₄, Li₁₋ₓNiO₂, and Li₁₋ₓCoO₂, x is greater than 0 and not greater than 1. In LiₓNi_{y}Co_{z}Al_{1-y-z}O₂, each of x, y, and z is greater than 0 and not greater than 1, and a sum of y and z is greater than 0 and not greater than 1. The negative electrode active material includes hard carbon.

In addition, the controller detects a voltage of the lithium secondary battery and controls a charge operation for the lithium secondary battery such that the secondary battery can be charged with a maximum voltage of a linear voltage region. When a voltage of the lithium secondary battery is equal to or more than the maximum voltage, the controller stops the charge operation for the lithium secondary battery.

The hybrid cell further includes a charge control device for the lithium secondary battery, wherein the charge control device charges the lithium secondary battery using the fuel cell or an external power while being controlled by the controller. In addition, the controller performs an operation in a region, where a linear voltage profile of the lithium secondary battery is presented, in order to hybridize the lithium secondary battery with the fuel cell. The controller is installed in the lithium secondary battery or the fuel cell.

The voltage profile of the lithium secondary battery is a linear line, which is parallel to a discharge voltage profile of the fuel cell. The voltage profile of the lithium secondary battery can be formed with a linear line, which matches with a discharge voltage profile of the fuel cell. The voltage profile of the lithium secondary battery can be proportional to a discharge voltage profile of the fuel cell and has a gradient different from that of the discharge voltage profile of the fuel cell.

Another aspect of the invention provides a method of driving a hybrid cell consisting of a lithium secondary.battery and a fuel cell, the method comprising the steps of: establishing a linear voltage region of the lithium secondary battery and a maximum voltage in the linear voltage region; detecting a voltage of the lithium secondary battery; charging the lithium secondary battery if the voltage of the lithium secondary battery is less than the maximum voltage; and stopping the charge operation for the lithium secondary battery if the voltage of the lithium secondary battery is equal to or more than the maximum voltage.

The method further includes the steps of: establishing a minimum voltage in the linear voltage region of the lithium secondary battery; detecting an output voltage and an output current of the fuel cell; determining whether an output power of the fuel cell is suddenly decreased; discharging the lithium secondary battery when the output power of the fuel cell is suddenly decreased; and stopping the discharge operation for the lithium secondary battery if the voltage of the lithium secondary battery is equal to or less than the minimum voltage.

### BRIEF DESCRIPTION OF THE DRAWINGS

The above and other features and advantages of the present invention will be more apparent from the following detailed description taken in conjunction with the accompanying drawings, in which:

FIG. 1 is a schematic perspective view illustrating an electrode assembly of a lithium secondary battery according to an embodiment of the present invention;

FIG. 2a is a graph illustrating an electric potential of a positive electrode active material according to an embodiment of the present invention;

FIG. 2b is a schematic cross-sectional view illustrating a negative electrode active material according to an embodiment of the present invention;

FIG. 3 is a graph illustrating linear voltage profiles of a lithium secondary battery, a fuel cell and an EDLC during the charge/discharge operations;

FIGS. 4a and 4b are graphs illustrating combination of positive electrode active materials and voltage profiles during the charge/discharge operations according to an embodiment of the present invention;

FIG. 5 is a schematic circuit diagram of a hybrid cell according to an embodiment of the present invention;

FIG. 6a is a graph illustrating voltage profiles of a lithium secondary battery and a fuel cell according to an embodiment of the present invention;

FIG. 6b is a graph illustrating voltage profiles of a lithium secondary battery and a fuel cell according to another embodiment of the present invention; and

FIG. 6c is a graph illustrating voltage profiles of a lithium secondary battery and a fuel cell according to still another embodiment of the present invention.

### DETAILED DESCRIPTION OF CERTAIN INVENTIVE EMBODIMENTS

Hereinafter, certain embodiments of the invention will be described with reference to the accompanying drawings. In the drawings, like reference numerals indicate the same or functionally similar elements.

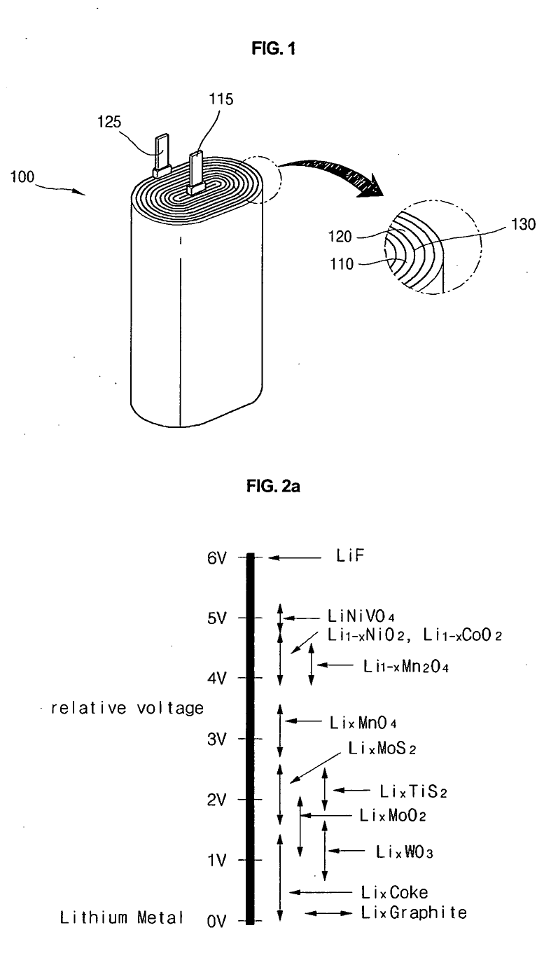

FIG. 1 is a perspective view illustrating an electrode assembly 100 of a lithium secondary battery according to an embodiment. The electrode assembly 100 includes a positive electrode plate 110 having a positive electrode collector formed at a predetermined portion thereof with a positive electrode active material, a negative electrode plate 120 having a negative electrode collector formed at a predetermined portion thereof with a negative electrode active material, and a separator interposed between the positive electrode plate 110 and the negative electrode plate 120. The separator is configured to prevent a short circuit from occurring between the positive and negative electrode plates 110 and 120 while allowing lithium ions to move exclusively. The positive electrode plate 110, the negative electrode plate 120 and the separator 130 are wound in the form of a jellyroll.

Lithium oxide, such as LiCoO₂, LiMn₂O₄, LiNiO₂, or LiMnO₂, can be used as a positive electrode active material. In addition, carbon-based materials, Si, Sn, tin oxides, composite tin alloys, transition metal oxides, lithium metal nitrides or lithium metal oxides can be used as a negative active material. The positive electrode collector of the positive electrode plate 110 may be made from aluminum. The negative electrode collector of the negative electrode plate 120 may be made from copper. The separator 130 may be made from a polyolefin-based material, such as porous polyethylene (PE) or polypropylene (PP).

Hereinafter, a basic principle of a lithium ion secondary battery will be briefly described. When a chemical reaction occurs between two different materials, electrons move from one material to the other material. The reaction occurs at a standard electrode potential, which may vary depending on the materials. In addition, a potential difference is created between materials having different electric potentials. Thus, the battery generates power by using the potential difference between different materials.

A lithium ion secondary battery is a battery employing a chemical intercalation. The lithium ion secondary battery includes positive and negative electrode active materials, into which lithium can be electrochemically intercalated, and a non-aqueous organic solvent electrolyte, which is a medium for moving lithium ions. During the discharge operation, the reaction proceeds such that the electric potential of the positive electrode becomes low so that the positive electrode is reduced while obtaining electrons. In contrast, the negative electrode loses the electrons so that the electric potential of the negative electrode increases. The total energy of the system is reduced during the discharge operation. The reduced energy is transferred to an external wire, and is provided as a direct-current electric energy.

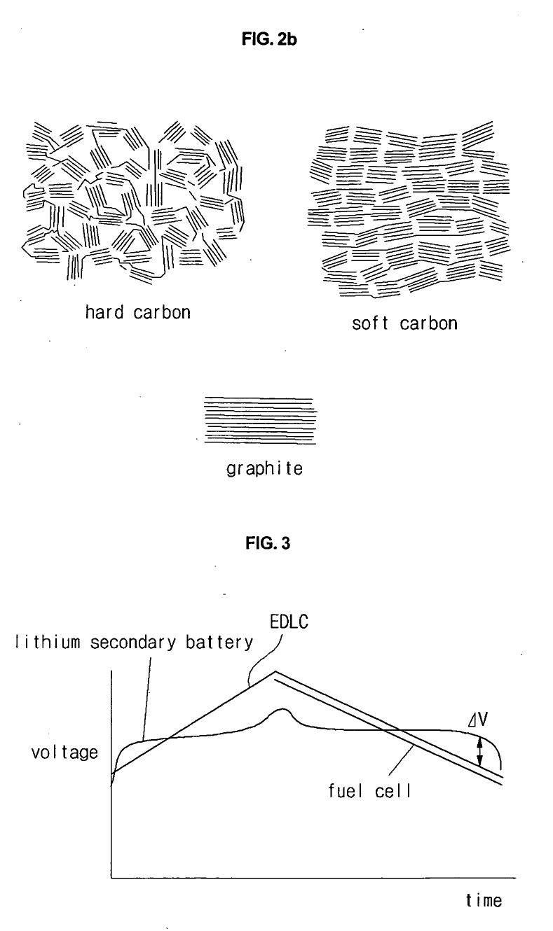

The positive and negative electrode active materials have a higher cell voltage as the potential difference thereof increases. In the case of the lithium ion secondary battery, the cell voltage is expressed as a difference of electrochemical potential (−Δ G/nF) of lithium, which is intercalated into the positive and negative electrode active materials. A normal lithium ion secondary battery employs a positive electrode active material including oxides of Ni, Co or Mn, which can generate about 4V when it is incorporated with lithium, and a negative electrode active material including carbon, which can form lithium intercalation carbon (LIC) having a voltage of about 0 to 1V when it is incorporated with lithium. In this case, the normal lithium ion secondary battery has a relatively high cell voltage having an average potential difference of about 3.6V. Referring to FIG. 2a, when lithium cobalt oxide having an electric potential of about 4 to 4.5V is used as a positive electrode and carbon having an electric potential of about 0.5V is used as a negative electrode, it is possible to fabricate a battery generating a voltage of about 3.5 to 4V, theoretically.

In this case, graphite, soft carbon, or hard carbon can be used as a negative electrode active material. FIG. 2b shows structures of graphite, soft carbon, and hard carbon. In the case of graphite, an interlayer distance is about 0.335 nm. However, the interlayer distance becomes about 0.372 nm when lithium is doped into graphite. If lithium is separated from graphite, the interlayer distance of graphite becomes about 0.335 nm again. However, if such compression and shrinkage of graphite is repeated, the electrode assembly expands and the crystalline structure of graphite is broken, thereby degrading the cycle characteristic. Although soft carbon also has a layered structure similar to that of graphite, cavities are formed in the layered structure of soft carbon. The structure of hard carbon is completely different from that of graphite or cokes. That is, unlike graphite having the layered structure consisting of hundreds of stacks, the layered structure of hard carbon includes several layers. Instead, the layered structure of hard carbon includes micro crystals defined by predetermined spaces. Since the surface-interval of the micro crystals is equal to or more than about 0.337 nm, the degree of compression and shrinkage between layers of hard carbon is reduced, so that hard carbon has superior cycle characteristics. In addition, a greater amount of lithium ions can be doped into hard carbon, so that it is possible to obtain a battery having a high capacity. When hard carbon is used as a negative electrode active material, the discharge voltage of battery tends to slowly decrease and the voltage profile is substantially linear.

Therefore, if the positive electrode active material is selected from lithium oxides shown in FIG. 2a and graphite is selected as a negative electrode active material, the voltage potential of the lithium ion secondary battery can be fixed to a predetermined level. Thus, as to a voltage profile, the potential value is constant except for some regions, such as an overcharge region or an over-discharge region. Accordingly, a plateau region exists in a graph in the form of a constant function, which is substantially parallel to an x-axis. Such a potential plateau relates to the characteristics of electronic appliances, and a superior potential plateau can be obtained as potential variation is reduced during the discharge operation. If metal lithium is used as a positive electrode active material, variation of the electrochemical potential of the electrode may be reduced during the charge/discharge operation, so the superior potential plateau can be obtained. However, the metal lithium causes a problem in terms of safety.

In the case of an intercalation material, such as lithium cobalt oxide (LiCoO₂), a high crystal material having crystal gratings, which have been sufficiently developed, may represent potential variation less than that of a low crystal material including an amorphous material during the intercalation process, so the high crystal material represents superior potential plateau.

FIG. 3 shows voltage profiles of the lithium secondary battery, the EDLC and the fuel cell. The transverse axis represents time and the longitudinal axis represents the electric potential when the charge/discharge rate is constant. Referring to FIG. 3, as mentioned above, the voltage profile of the lithium secondary battery is substantially horizontal except for some regions, such as an overcharge region and an over-discharge region. In contrast, the voltage profile of the fuel cell is in the form of a straight line having a negative gradient. Since the fuel cell is an energy converter, the electric potential is decreased from a high electric potential to a low electric potential in a predetermined ratio so long as fuel is continuously fed into the fuel cell.

Thus, a complex controller must be provided in order to hybridize the fuel cell with the lithium secondary battery having the voltage profile different from that of the fuel cell. That is, the controller is necessary in the hybrid cell in order to convert or stabilize the output voltage of the cell. In general, a switching converter is used as a part of the controller. The switching converter can expand the run time of the battery by reducing the output voltage of the battery at the initial stage of the discharge operation when a load circuit excessively provides a power due to an excessive voltage provided thereto from the battery. In addition, the switching converter can expand the run time of the battery by increasing the output voltage of the battery at the end of the discharge operation when the output voltage of the battery is lower than a predetermined voltage level required by the load circuit. That is, the controller turns on/off the switching converter in the controller and maintains the output voltage of the battery at a minimum level when an input voltage is equal to or lower than an operating voltage for a typical electronic device. In addition, the controller reduces output impedance of the battery, determines an optimum discharge length, and measures a residual run time of the battery.

In order to control the current of the fuel cell, in which a voltage profile function is represented in the form of a linear function, or the current of the lithium secondary battery, in which a voltage profile function is represented in the form of an irrational function, a constant function or a high-order function, the controller must perform complicated operations. In the voltage profile of the lithium secondary battery shown in FIG. 3, a gap (Δ V) exists between the voltage profile of the fuel cell and the voltage profile of the lithium secondary battery. The controller detects the gap (Δ V) in real time and checks the voltage of each secondary battery in order to stop the discharge operation of the lithium secondary battery and to convert a battery mode into a charge mode. This is because the function of the hybrid cell may be deteriorated even if the lithium secondary battery is partially over-discharged. In addition, when the lithium secondary batteries are serially connected to each other, if one of the lithium secondary batteries is subject to disconnection due to the overcharge or over-discharge, the lithium secondary batteries cannot perform their functions, thereby causing a fault to an electronic appliance. In addition, since it is difficult to manufacture the controller capable of performing the complicated operations, only a few companies possess such a controller.

However, as shown in FIG. 3, the EDLC represents a linear voltage profile similar to that of the fuel cell. Thus, the controller performs a simple operation when hybridizing the fuel cell with the EDLC. In addition, in general, the controller charges the cell with a current by measuring the electric potential of the capacitor in real time so that the circuit structure of the computer is simplified.

According to current studies and research for high-capacity super capacitors, the power density per volume or weight is sufficient, but the energy density per volume or weight is very low. Thus, studies have been variously performed in order to effectively increase the energy density per volume or weight. One of them is to increase operational electric potential per unit super capacitor. This is because energy of the EDLC is proportional to the square of voltage as shown in Equation 1.
E=0.5 CV² Equation 1

However, current super capacitors represent the operational voltage of about 2.3V although they are fabricated to have the operational voltage of about 2.7V. In addition, there has been suggested a hybrid capacitor capable of increasing the electric potential. The hybrid capacitor has a negative electrode made from graphite enabling lithium intercalation and a positive electrode made from activated carbon. However, according to the hybrid capacitor, an intercalation mechanism is employed only for a surface of a negative electrode active material, so the hybrid capacitor may not be called a “battery” in a true sense. In addition, the hybrid capacitor has problems in terms of capacity. In addition, there has been provided another hybrid capacitor including a positive electrode made from a normal active material and a negative electrode made from activated carbon. However, according to this hybrid capacitor, the electric potential of the negative electrode is not sufficiently low, so the operational voltage of the hybrid capacitor is very low although the capacity of the hybrid capacitor is two times higher than that of the EDLC.

In contrast, the lithium secondary battery has a relatively high electric potential (a maximum voltage of about 4.2V). The battery thus has a high energy density. In addition, since the intercalation mechanism is employed at both the negative and positive electrodes, the lithium secondary battery has a high capacity. Therefore, if the lithium secondary battery has the linear voltage profile similar to that of the fuel cell, the lithium secondary battery can be hybridized with the fuel cell without using an expensive controller.

As described above, the lithium secondary battery has a plateau in the voltage profile due to the characteristic of activated carbon. According to one embodiment, positive electrode active materials having plateaus in various voltage levels are used in the electrode by mixing the positive electrode active materials with one another. In addition, the plateau is adjusted by controlling the amount of the positive electrode active materials being used, thereby obtaining the voltage profile having a sloped linear line. A linear voltage profile may be obtained by using hard carbon as a negative electrode active material with or without the control of positive electrode active material.

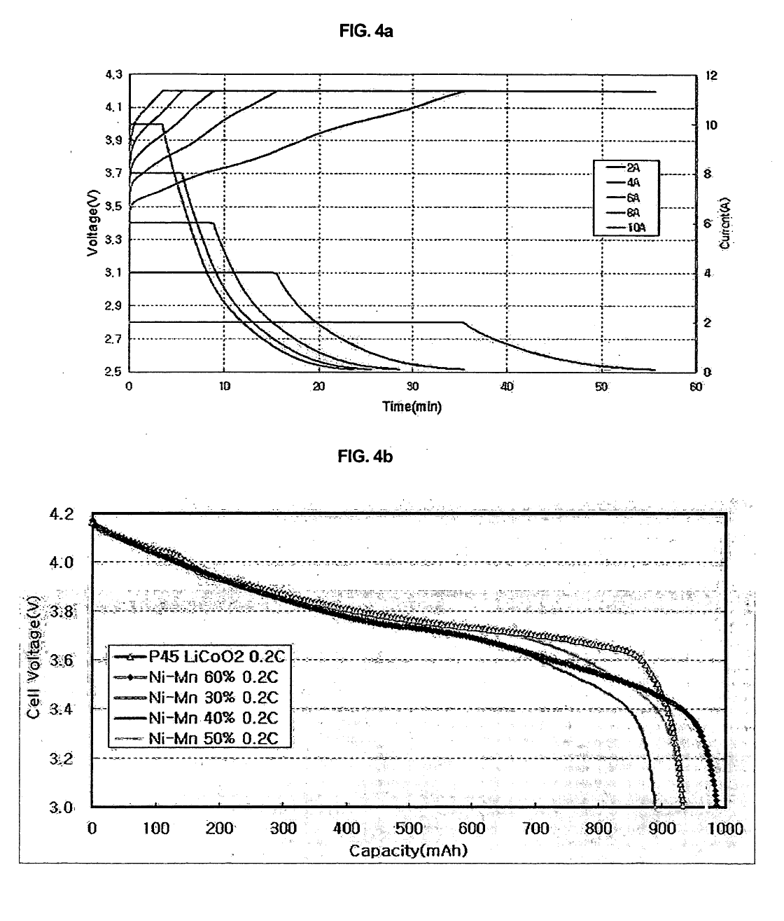

FIGS. 4a and 4b are graphs illustrating combination of positive electrode active materials and voltage profiles thereof according to an embodiment.

Referring to FIG. 4a, LiNi_{1/3}Co_{1/3}Al_{1/3}O₂ is mixed with LiMn₂O₄ at a weight ratio of about 5:5. In addition, a positive electrode active material layer is fabricated by using about 90% of an active material, about 5% of a conductive agent, and about 5% of a binder. A negative electrode active material layer is fabricated by using about 95% of natural graphite and about 5% of a binder. In addition, 1.3M LiPF₆ is used as an electrolyte, in which a weight ratio of ethylene carbonate (EC) to diethyl carbonate (DEC) is about 1:1. The capacity is about 1000 mAh and the charge operation is performed at a speed of about 2 C-10 C/sec. In the graph shown in FIG. 4a, the transverse axis represents time (min) and the longitudinal axis represents voltage (V).

In FIG. 4a, five lines having a positive gradient are voltage profiles as a function of time and five lines having a negative gradient are current profiles as a function of time. Referring to the voltage profiles, the gradients of the voltage profiles are different from each other depending on the charge speed. In certain regions, the gradients of the voltage profiles are substantially constant, that is, linear voltage profiles are obtained. As the charge speed increases, the region representing the linear voltage profile is reduced, but the voltage profile has a steep slope. In contrast, as the charge speed decreases, the region representing the linear voltage profile is enlarged, but the voltage profile has a gentle slope. That is, it is possible to enlarge the region representing the linear voltage profile by lowering the charge speed. In addition, the voltage value is constantly maintained at the level of about 4.2V after the linear voltage region regardless of the charge speed. Referring to the current profile, in the region representing the linear voltage profile, the current has a specific value corresponding to the charge speed. If the voltage value reaches a predetermined level, the current value is gradually reduced. FIG. 4a shows the voltage profile obtained in the charge operation, and FIG. 4b shows the voltage profile obtained in the discharge operation, the result of which is similar to that of FIG. 4a.

Referring to FIG. 4b, LiNiCoMnO₂ is mixed with Li₂CoO₂ in a different mixing ratio and the discharge voltage profile is measured. In the graph shown in FIG. 4b, Ni-Mn refers to LiNiCoMnO₂. In addition, about 1.0M LiPF₆ solution is used as an electrolyte, in which a ratio of ethylene carbonate (EC): ethyl-methyl-carbonate (EMC): propylene carbonate (PC) is about 30:65:5. In the graph shown in FIG. 4b, the transverse axis represents capacity (mAh) and the longitudinal axis represents voltage (V). As shown in FIG. 4b, although there is no specific tendency related to the mixing ratio of two materials, the linear voltage profile is shown in most regions. For instance, when about 40% of LiNiCoMnO₂ is used, the linear voltage profile is continuously represented until it reaches the region of 850 mAh. In addition, when about 30% of LiNiCoMnO₂ is used, the linear voltage profile is continuously represented until it reaches the region of 900 mAh.

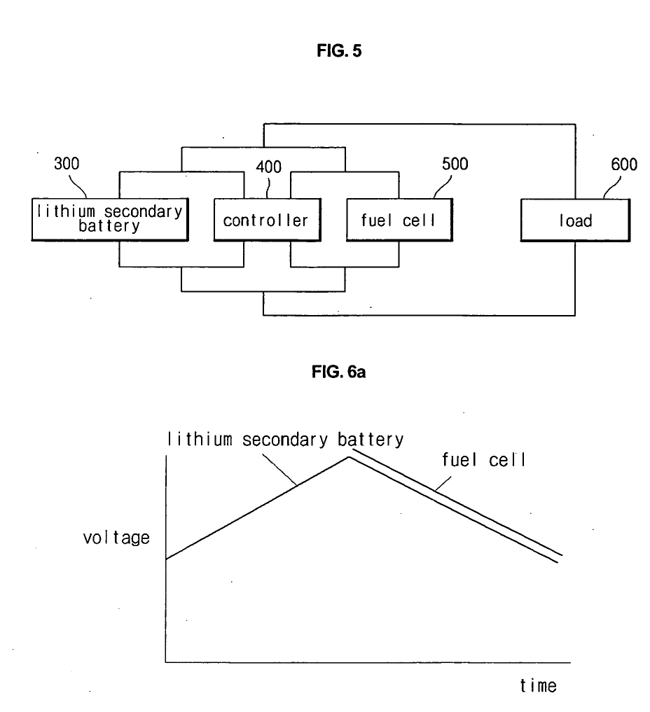

FIG. 5 is a circuit diagram of a hybrid cell according to an embodiment of the present invention. Referring to FIG. 5, a lithium secondary battery 300 is connected to a fuel cell 500 in parallel and a controller 400 is interposed between the lithium secondary battery 300 and the fuel cell 500 so as to control the voltage and current of the lithium secondary battery 300 and the fuel cell 500. When the battery is installed in a portable appliance having a small capacity, the lithium secondary battery 300 may be provided in the form of a single cell. However, when the battery is used for a vehicle requiring the high capacity and high voltage, a battery pack including a plurality of lithium secondary batteries is used.

In one embodiment, the controller 400 is installed adjacent to the lithium secondary battery 300 or the fuel cell 500. The controller 400 controls the charge/discharge current by measuring the voltage of the lithium secondary battery 300 and the fuel cell 500 in real time. The reason for installing the controller 400 adjacent to the lithium secondary battery 300 or the fuel cell 500, rather than a load 600, is that the controller including the switching converter may generate EMI (electromagnetic interference) exerting a bad influence upon an adjoining circuit. If the switching converter is installed adjacent to the lithium secondary battery 300 or the fuel cell 500, the EMI source can be positioned away from the electronic appliances sensitive to EMI, so that EMI can be shielded by means of a conductive case of the lithium secondary battery 300 or the fuel cell 500. In addition, in a case when a converter is necessary only for a specific electrochemical cell in order to convert or stabilize the output voltage of the cell, it is possible to design the load without the converter by dedicating the converter to the cell requiring the converter. In this case, the size of the circuit structure can be minimized and loss derived from the converter may not exert upon the cell and the load, which do not require the converter.

In addition, the controller 400 can control the charge operation for the lithium secondary battery 300. The controller 400 detects the voltage of the lithium secondary battery 300 and charges the lithium secondary battery 300 with a maximum voltage in the linear voltage region. If the detected voltage of the lithium secondary battery 300 exceeds the maximum voltage, the controller 400 stops the charge operation for the lithium secondary battery 300. The controller 400 detects the output voltage and output current of the fuel cell 500 by using a power converter. In the transient state, that is, if the output of the fuel cell 500 is suddenly dropped because the fuel cell 500 is required to provide excessive power beyond its capacity, the controller 400 combines the output of the fuel cell 500 with the output of the lithium secondary battery 300 by controlling the power converter such that the power can be normally provided toward the load 600. In addition, the controller 400 compares a digital signal, which is input into the controller 400 from a detecting unit, with a reference signal and generates a control signal according to the result of comparison. Here, the reference signal has a level corresponding to a maximum reference value, which is equal to the maximum voltage in the linear voltage region of the lithium secondary battery 300, or a minimum reference value, which is equal to the minimum voltage in the linear voltage region of the lithium secondary battery 300.

In addition, the hybrid cell further includes a charge control device for the lithium secondary battery 300. When the lithium secondary battery 300 is subject to the charge operation, each cell may react differently with the charge current. For this reason, the charge control device is coupled with the lithium secondary battery 300 in order to individually control the charge/discharge operation of the cells. The charge control device may include a plurality of bypass switching units. The bypass switching units are coupled to each cell in a row in order to bypass over-current applied to specific cells, thereby preventing the cells, which have been overcharged during the charge cycle of the lithium secondary battery 300, from reacting with other cells or being damaged.

FIG. 5 is an example of the hybrid cell system. The controller can be installed in the lithium secondary battery in order to control the charge/discharge voltage of the lithium secondary battery. In this case, the controller is provided at a passage, where the lithium secondary battery and the fuel cell are connected to the load, so as to control the amount of current applied to the load.

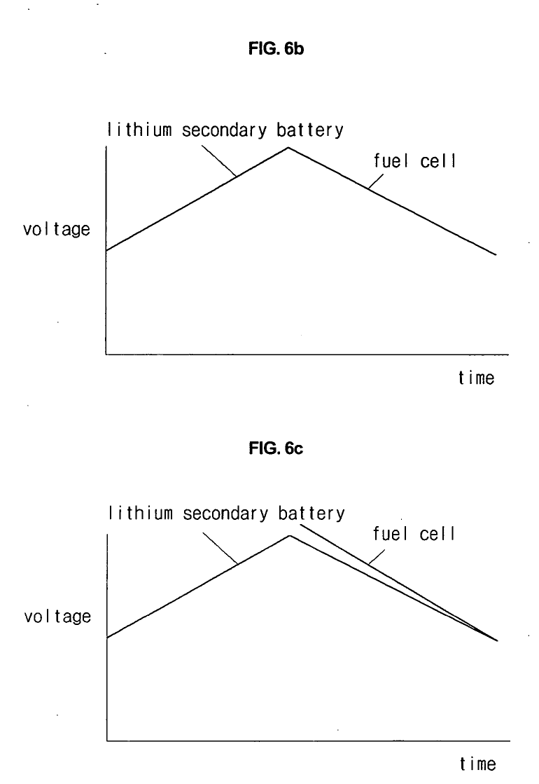

FIGS. 6a, 6b and 6c are views illustrating voltage profiles of the lithium secondary battery during the charge/discharge operations and voltage profiles of the fuel cell during the discharge operation according to an embodiment.

Referring to FIG. 6a, the lithium secondary battery has a voltage profile representing a gradient identical to that of the fuel cell and a y-intercept different from that of the fuel cell, so the voltage profiles of the lithium secondary battery and the fuel cell are linearly formed in parallel to each other. Although FIG. 6a shows the linear voltage profile of the lithium secondary battery, the linear voltage profile of the lithium secondary battery may appear only in a certain region of the voltage profile and hybridization may occur at the region. In this case, the controller performs operations at the region, where the voltage profile of the lithium secondary battery is linearly formed, thereby hybridizing the lithium secondary battery and the fuel cell. At this time, since the voltage value of the fuel cell can be obtained by adding a predetermined value to the voltage value obtained in the specific region, the controller simply performs adding and subtracting operations.

Referring to FIG. 6b, the lithium secondary battery has a voltage profile representing a gradient and a y-intercept identical to those of the fuel cell, so the voltage profile of the lithium secondary battery matches with that of the fuel cell while forming a linear line. In this case, the controller can control the lithium secondary battery and the fuel cell by measuring the voltage of the lithium secondary battery or the fuel cell, and thus the controller may not have to perform a specific operation. That is, the voltage of the lithium secondary battery can be obtained by measuring the voltage of the fuel cell or vice versa, the control mechanism of the controller can be simplified.

Referring to FIG. 6c, the lithium secondary battery and the fuel cell have a voltage profile in the form of a linear line. The voltage profile of the lithium secondary battery has a gradient different from that of the fuel cell. In this case, the linear lines have a ratio of similarity corresponding to the gradients thereof. Accordingly, since the voltage value of the fuel cell can be obtained by multiplying the voltage value obtained in the linear voltage region by a predetermined value corresponding to the ratio of similarity, the controller simply performs multiplying and dividing operations.

In addition, although it is not illustrated in the drawings, the voltage profile can be obtained by mixing the voltage profile shown in FIG. 6a with the voltage profile shown in FIG. 6c. That is, the voltage profiles of the lithium secondary battery and the fuel cell may have a parallel region where the voltage profiles are parallel to each other and a region where the voltage profiles have gradients different from each other. In this case, the controller performs the adding or subtracting operation in the parallel region, and the multiplying or dividing operation in the region where the voltage profiles have gradients different from each other.

As shown in FIGS. 6a to 6c, when the linear region appears in the voltage profile of the lithium secondary battery, the controller measures the voltage value and performs the four operations of arithmetic, so that the controller can control the lithium secondary battery and the fuel cell in real time. Therefore, an expensive controller is not necessary. That is, it is possible to control the lithium secondary battery and the fuel cell in real time by using the controller, which is used in a conventional hybrid cell including a fuel cell and an EDLC. In addition, similar to the voltage profile shown in FIG. 6a, if the linear voltage region is partially formed in the voltage profiles shown in FIGS. 6b and 6c, the hybrid cell is formed only in the linear voltage region.

In other regions, where the voltage profile of the lithium secondary battery has a non-linear shape, the controller can select an energy source so as to selectively operate the fuel cell or the lithium secondary battery. In this case, the hybrid system according to the embodiments can be applied to most linear regions except for the non-linear region where only one energy source is employed.

Hereinafter, a driving method for the hybrid cell according to an embodiment will be described. The method of driving the hybrid cell includes the steps of establishing a linear voltage region of the lithium secondary battery 300 and a maximum voltage in the linear voltage region, detecting the voltage of the lithium secondary battery 300, charging the lithium secondary battery 300 if the voltage of the lithium secondary battery is less than the maximum voltage, and stopping the charge operation for the lithium secondary battery 300 if the voltage of the lithium secondary battery 300 is equal to or more than the maximum voltage.

First, the linear voltage region of the lithium secondary battery 300 and the maximum and minimum voltage values in the linear voltage region are preset in the controller 400. Then, the controller detects the charge voltage of the lithium secondary battery 300 and determines whether the charge voltage of the lithium secondary battery 300 is less than the maximum voltage. If it is determined that the charge voltage of the lithium secondary battery 300 is less than the maximum voltage, the lithium secondary battery 300 is charged. In contrast, if it is determined that the charge voltage of the lithium secondary battery 300 is not less than the maximum voltage, the next step is performed without charging the lithium secondary battery 300.

After that, the controller 400 determines whether the detected charge voltage of the lithium secondary battery 300 is equal to or more than the maximum voltage. If it is determined that the detected charge voltage of the lithium secondary battery 300 is equal to or more than the maximum voltage, the controller 400 stops the charge operation for the lithium secondary battery 300. In contrast, if it is determined that the detected charge voltage of the lithium secondary battery 300 is less than the maximum voltage, the controller 400 continuously checks the charge voltage of the lithium secondary battery 300.

Through the above procedure, the controller 400 controls the charge and discharge operations for the lithium secondary battery 300 such that the lithium secondary battery 300 can wait in the linear voltage region. According to the embodiments, the lithium secondary battery 300 is combined with the fuel cell 500 based on the linear voltage region, so that the lithium secondary battery 300 having the capacity higher than that of a super capacitor can be easily and simply combined with the fuel cell 500.

Hereinafter, the operation of the hybrid cell according to an embodiment will be described. Referring to FIG. 5, if a linear region appears in at least one region of the voltage profile of the lithium secondary battery 300 by combining positive electrode active materials having various electric potentials, the controller 400 installed adjacent to the lithium secondary battery 300 or the fuel cell 500 may operate. When the load 600 requiring the high voltage is applied, such as a driving motor of a vehicle, the lithium secondary battery 300 is discharged and the power discharged from the lithium secondary battery 300 is used as a main power until the fuel cell 500 is normally operated. The controller 400 measures the electric potential of the lithium secondary battery 300 in real time so as to control the lithium secondary battery 300 such that the lithium secondary battery 300 is not over-discharged. When the lithium secondary battery 300 has been discharged to a predetermined voltage level, the fuel cell 500 is discharged, thereby supporting the main power.

The operation of the controller 400 in the non-linear voltage region of the lithium secondary battery 300 is different from that of the controller 400 in the linear voltage. region. In the non-linear voltage region, the lithium secondary battery 300 or the fuel cell 500 is individually discharged. However, if a controller capable of controlling both the lithium secondary battery 300 and the fuel cell 500 in the non-linear voltage region is provided instead of the controller employed in the embodiments, the hybrid system may be realized regardless of the non-linear region.

Referring to FIGS. 6a to 6c, the controller measures the voltage of the lithium secondary battery and the fuel cell and simply performs the four operations of arithmetic in order to control the current during the charge/discharge operations, thereby realizing the hybrid battery system.

As described above, according to the hybrid cell and the method of driving the hybrid cell of the embodiments, it is possible to provide the lithium secondary battery having the linear voltage profile, so that the fuel cell can be hybridized with the lithium secondary battery, instead of the super capacitor, thereby obtaining a small-sized hybrid cell having a relatively higher capacitor.

In addition, according to the embodiments, since the lithium secondary battery has an operational voltage higher than that of the super capacitor, the number of stacks in the fuel cell can be reduced, and the controller used in the conventional hybrid cell can be utilized in the hybrid cell according to present invention, so that the cost is reduced and the circuit structure of the controller can be simplified.

Although certain embodiments have been described for illustrative purposes, those skilled in the art will appreciate that various modifications, additions and substitutions are possible, without departing from the scope and spirit of the invention as disclosed in the accompanying claims.

What is claimed is:

1. A hybrid cell comprising:
a lithium secondary battery comprising an electrode assembly and a housing for accommodating the electrode assembly therein, the electrode assembly comprising:
a positive electrode comprising a positive electrode active material, and
a negative electrode comprising a negative electrode active material,
wherein the lithium secondary battery comprises a substantially linear time-to-voltage profile in at least part of a charging and discharging cycle thereof;
a fuel cell electrically connected to the lithium secondary battery; and
a controller for controlling the lithium secondary battery and the fuel cell.

2. The hybrid cell of claim 1, wherein the lithium secondary battery has a substantially linear time-to-voltage profile with a negative slope while discharging.

3. The hybrid cell of claim 1, wherein the positive electrode active material comprises at least two materials selected from the group consisting of LiₓWO₃, LiₓMoO₂, LiₓTiS₂, LiₓMoS₂, LiₓMnO₄, Li₁₋ₓMn₂O₄, Li₁₋ₓNiO₂, Li₁₋ₓCoO₂, LiNiVO₄, LiF, and LiₓNi_{y}Co_{z}Al_{1-y-z}O₂, wherein each of x, y and z is greater than 0 and not greater than 1, and wherein a sum of y and z is greater than 0 and not greater than 1.

4. The hybrid cell of claim 3, wherein the positive electrode active material comprises LiNi_{1/3}Co_{1/3}Al_{1/3}O₂ and LiMn₂O₄.

5. The hybrid cell of claim 4, wherein a weight ratio of LiNi_{1/3}Co_{1/3}Al_{1/3}O₂ to LiMn₂O₄ is about 1:1.

6. The hybrid cell of claim 4, wherein the negative electrode active material comprises graphite.

7. The hybrid cell of claim 1, wherein the positive electrode active material comprises LiNiCoMnO₂ and Li₂CoO₂.

8. The hybrid cell of claim 1, wherein the negative electrode active material comprises hard carbon comprising micro crystals having a surface interval of about 0.337 nm or greater.

9. The hybrid cell of claim 1, wherein the controller is configured to detect a voltage level of the lithium secondary battery, and wherein the controller is further configured to control charging of the lithium secondary battery such that the secondary battery is charged to a predetermined voltage in accordance with the substantially linear voltage profile.

10. The hybrid cell of claim 9, wherein, when the voltage level of the lithium secondary battery is equal to or greater than a first voltage, the controller is configured to stop charging the lithium secondary battery.

11. The hybrid cell of claim 1, further comprising a charge control device configured to charge the lithium secondary battery using the fuel cell or an external power.

12. The hybrid cell of claim 1, wherein the controller is configured to control at least one of the lithium secondary battery and the fuel cell in the at least part of the charging and discharging cycle.

13. The hybrid cell of claim 1, wherein the fuel cell has a discharge voltage profile, at least part of which is substantially linear, and wherein the substantially linear voltage profile of the lithium secondary battery is substantially parallel to the discharge voltage profile of the fuel cell.

14. The hybrid cell of claim 1, wherein the fuel cell has a discharge voltage profile, at least part of which is substantially linear, and wherein the substantially linear voltage profile of the lithium secondary battery substantially matches the discharge voltage profile of the fuel cell.

15. The hybrid cell of claim 1, wherein the fuel cell has a discharge voltage profile, at least part of which is substantially linear, and wherein the substantially linear voltage profile of the lithium secondary battery has a slope different from that of the discharge voltage profile of the fuel cell.

16. A method of driving a hybrid cell of claim 1, the method comprising:
detecting a voltage level of the lithium secondary battery;
charging the lithium secondary battery in accordance with a substantially linear voltage profile if the voltage level of the lithium secondary battery is substantially smaller than a first predetermined level; and
stopping charging the lithium secondary battery if the voltage level reaches about the predetermined level.

17. The method of claim 16, further comprising:
detecting an output voltage and an output current of the fuel cell;
determining whether an output power of the fuel cell has decreased;
discharging the lithium secondary battery in accordance with a substantially linear voltage profile if the output power of the fuel cell has suddenly decreased; and
stopping discharging the lithium secondary battery if the voltage level of the lithium secondary battery reaches about a second predetermined level.
